(19) United States
(12) Patent Application Publication
(10) Pub. No.: US 2008/0051236 A1
(43) Pub. Date: Feb. 28, 2008

(54) Stepless transmission for a flat planer

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/509,824

(22) Filed: Aug. 25, 2006

(51) Int. Cl. F16H 63/00; F16H 55/56

(52) U.S. Cl. 474/69; 474/12; 474/8

(57) ABSTRACT

A stepless transmission for a flat planer has a driving shaft connected with a motor and fitted with a driving cam member inside the stepless transmission, able to keep its wheelbase altered. The driving cam member is pivotally connected with a driven pulley set by means of a driving belt. The driven pulley set is correspondingly provided with a driven cam member having an adjustable wheelbase. The driving cam member can be driven by a jaw of a hand rod to keep the wheelbase of the driving cam member altered, so as to control a conveying speed of an input roller.

### BACKGROUND OF THE INVENTION

1. Field of the Invention

This invention relates to a flat planer, particularly to one installed with a stepless transmission able to keep an input roller of the planer moving with a stepless variable speed.

2. Description of the Prior Art

Commonly, a transmission 10 of a conventional planer mainly includes a driving gear set 11 and a driven gear set 12. The driving gear set 11 is provided with a drive shaft 111 linked with a motor of the planer (not shown in Fig.) and a gear set 112 fixed with the drive shaft 111. The gear set 112, provided with a high-speed gear 1121 and a low-speed gear 1122, can move axially along the drive shaft 111. In addition, the gear set 112 is engaged with the driven gear set 12 which is provided with a corresponding high speed gear 121 and a corresponding low speed gear 122. The corresponding low speed gear 122 of the driven gear set 12 is connected with an input roller 13, able to control the high-speed gear 1121 engaged with the corresponding high speed gear 121 of the driven gear set 12 or the low-speed gear 1122 engaged with the corresponding low speed gear 122 of the driven gear set 12, providing a high-speed or a low-speed input for the conventional planer. But, the mere two options of speed as said previously are too less for users to select, unable to satisfy practical requirement and necessary working precision.

### SUMMARY OF THE INVENTION

The objective of this invention is to offer a stepless transmission for a flat planer.

The main characteristics of the invention are a driving pulley set, a driven pulley set, a driving belt, a hand rod set and a switchgear set. The driving pulley set is provided with a driving shaft at its front end for connecting with a motor and a driving cam member fitted with the driving shaft, having an adjustable wheelbase. The driven pulley set is provided with a driven shaft pivotally fixed inside the stepless transmission, a driven cam member with an adjustable wheelbase, fitted with the driven shaft and corresponding to the driving cam member, and a compression spring fitted with the driven shaft, able to force elastically the driven cam member. The driving belt is mounted between the driving cam member and the driven cam member. The hand rod set is provided with a hand rod inserted inside the stepless transmission with a handle remained outside the stepless transmission, able to be turned with a preset angle to keep a jaw moved eccentrically so as to adjust the wheelbase of the driving cam member. The switchgear set is provided with a main shaft connected with the driven shaft and a switch shaft connected with an input roller of the planer. With the wheelbase change of the driving cam member reacted by the hand rod set and the radius change of the driving cam member and the driven cam member, the input roller can be changed with a stepless variable speeds as required, so as to achieve a required precision with an optimum working condition, saving cost, of course.

### BRIEF DESCRIPTION OF DRAWINGS

This invention is better understood by referring to the accompanying drawings, wherein:

FIG. 1 is a perspective view of a conventional transmission of a planer;

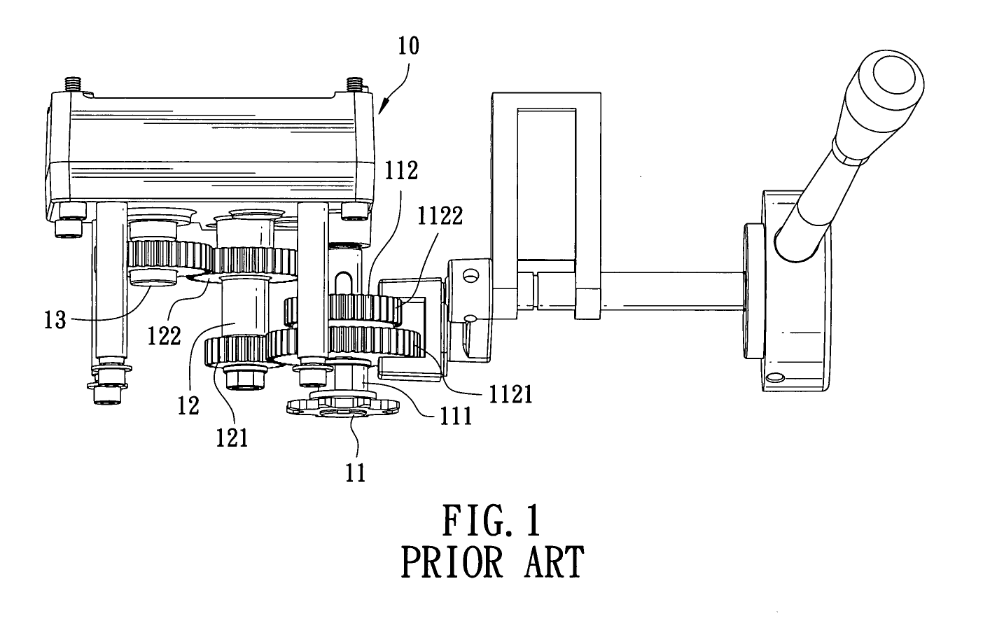

FIG. 2 is a perspective view of a preferred embodiment of a stepless transmission of a flat planer in the present invention;

FIG. 3 is a side view of a preferred embodiment of a stepless transmission of a flat planer in the present invention;

FIG. 4 is a perspective view of the preferred embodiment of a stepless transmission of a flat planer in the present invention;

FIG. 5 is an exploded perspective view of the preferred embodiment of a stepless transmission of a flat planer in the present invention;

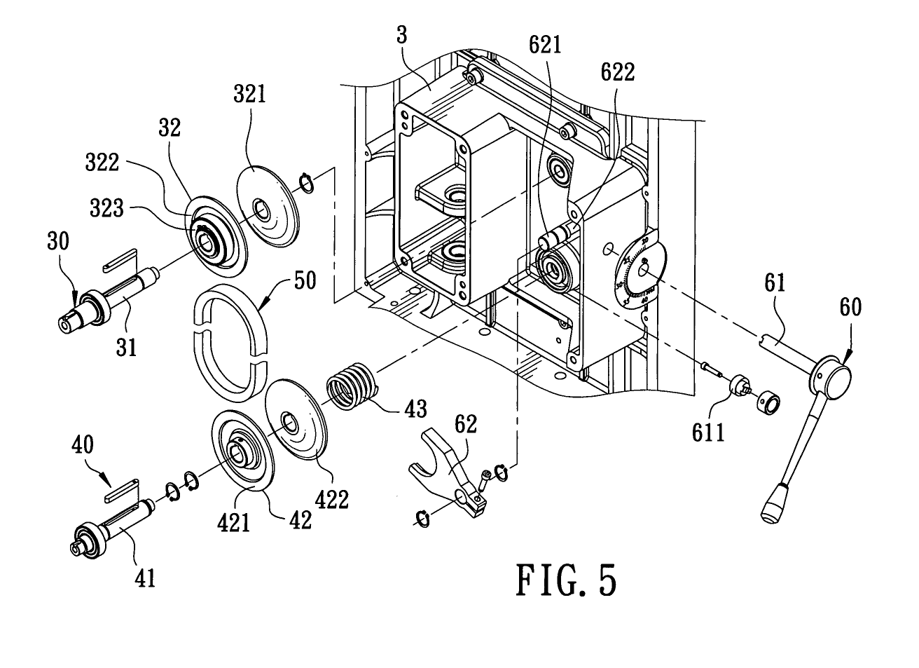

FIG. 6 is an illustrative view of the preferred embodiment of a stepless transmission of a flat planer in the present invention, showing it being speeded up; and

FIG. 7 is an illustrative view of the preferred embodiment of a stepless transmission of a flat planer in the present invention, showing it being slowed down.

### DETAILED DESCRIPTION OF THE PREFERRED EMBODIMENT

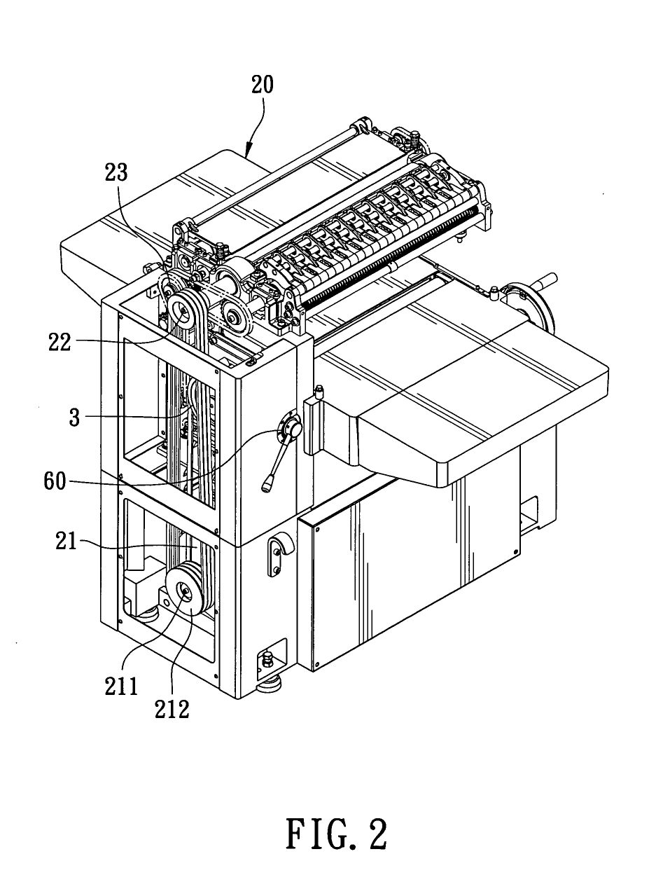

FIGS. 2˜5 show a preferred embodiment of a stepless transmission 3 for a flat planer in the present invention having a main base 20 that is fixed with a motor 21 inside it. The axis 211 of the motor 20 is installed with a pulley 212 to drive a knife shaft 22 pivotally connected with the motor 20 to rotate. In addition, an input roller 23 pivotally connected at two sides of the knife shaft 22 is driven by the stepless transmission 3, so as to keep a workpiece moved back and froth. The stepless transmission 3 installed outside the main base 20 is provided at least with a driving pulley set 30, a driven pulley set 40, a driving belt 50, a hand rod set 60 and switchgear set 70.

The driving pulley set 30 is provided with a driving shaft 31 fixed with a belt pulley 311 at its front end. The belt pulley 311 is mounted with a belt 312 that mounts on the pulley 212 of the motor 21, too. The driving shaft 31 is pivotally engaged with a driving cam member 32 inside the stepless transmission 3, having an adjustable wheelbase. The driving cam member 32 is composed of a first cam 321 projecting gradually from the outer circumference to the center and fixed on the driving shaft 31, a second cam 322 pivotally fixed on the driving shaft 31 and a bearing 323 also pivotally fixed on the driving shaft 31 outside the second cam 322.

The driven pulley set 40 is provided with a driven shaft 41 pivotally connected with the stepless transmission 3. The driven shaft 41 is provided with a driven chain gear 411 at its front end outside the stepless transmission 3 and a driven cam member 42 corresponding to the driving cam member 32 and having an adjustable wheelbase. The driven cam member 42 consists of a third cam 421 projecting gradually from the outer circumference to the center and fixed on the driven shaft 41, and a fourth cam 422 pivotally connected on the driven shaft 41. In addition, a compression spring 43 is fitted on the driven shaft 41 outside the forth cam 422, able to force elastically the fourth cam 422 axially.

The driving belt 50, a V-belt, is mounted between the driving cam member 32 and the driven cam member 42. And, the driving belt 50 is to have a definite tension because of being squeezed elastically by the compression spring 43 located outside the driven cam member 42.

The hand rod set 60 is composed of a hand rod 61 and a jaw 62. The hand rod 61 is inserted in the stepless transmission 3, keeping its handle remained outside the stepless transmission 3, able to be rotated with a preset angle. One end of the hand rod 61 inside the stepless transmission 3 is provided with an eccentric wheel 611. The jaw 62 is provided with a jaw shaft 621 that, pivotally set in the stepless transmission 3, intersects vertically with the hand rod 61 and has a driving groove 622 for containing the eccentric wheel 611. The front end of the jaw 62 is fixed outside the bearing 323, enabling the jaws 62 driven by movement of the eccentric wheel 611 to keep the second cam 322 reciprocating axially.

The switchgear set 70 consists of a main shaft 71, a worm 72 and a switch shaft 73. The main shaft 71 is provided with a main chain gear 711 at its front end, which is connected with the driven chain gear 411 by a chain 712, and a worm shaft 713 engaged with a worm gear 721 of the worm 72. The worm 72 is provided with a first bevel gear 722 at its top engaged correspondingly with a second bevel gear 731 of the switch shaft 73. The switch shaft 73 is provided with a switch chain gear 732 at its front end connected with the input roller 23 by a control chain 733.

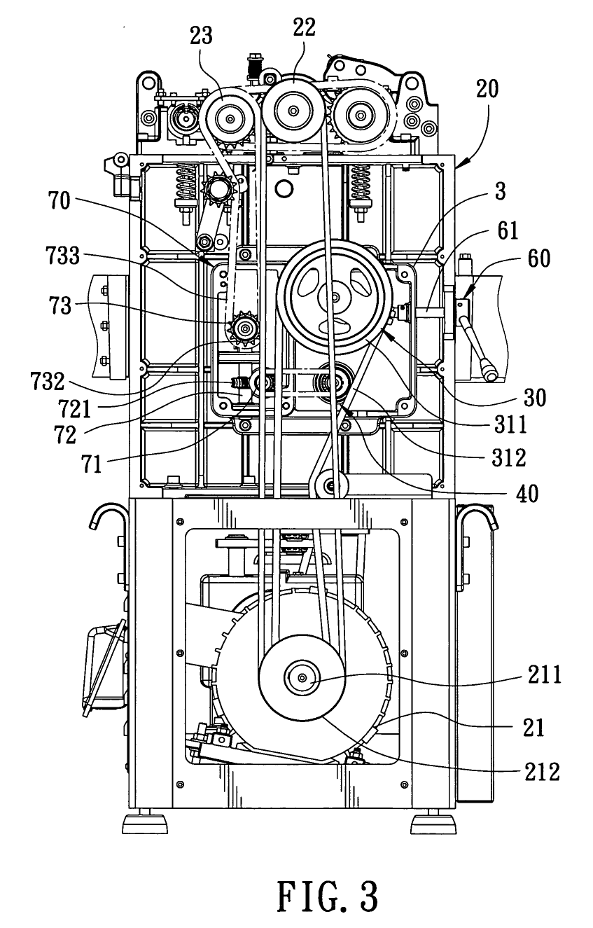

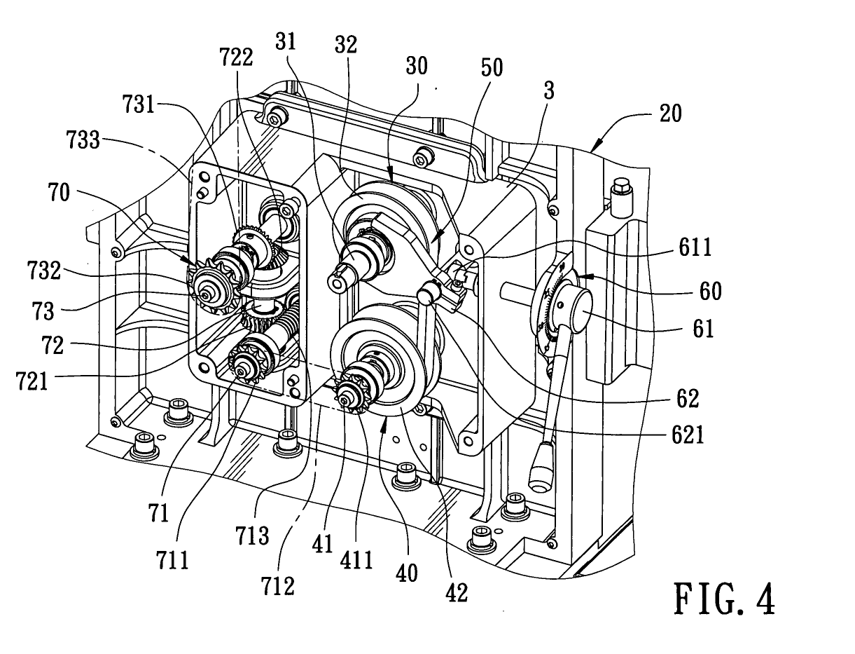

In using, as shown in FIGS. 3 and 4, the pulley 212 of the motor 21 is to drive the knife shaft 22 and the stepless transmission 3 to rotate while the planer is operating. By the time, the knife shaft 22 is to carry out planning and the stepless transmission 3 is to control the input roller 23 working properly to convey a workpiece to the knife shaft 22 for planning.

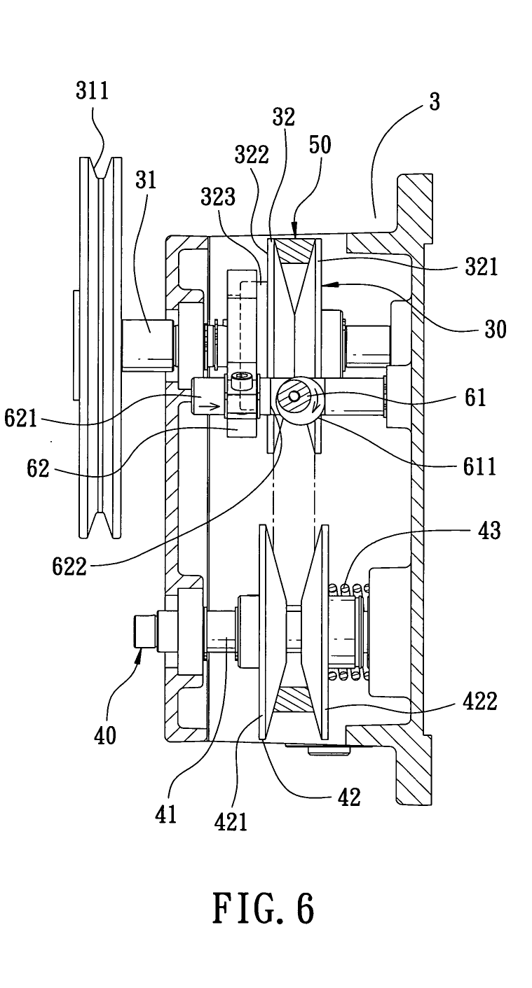

As shown in FIG. 6, when it is hoped to speed up the input roller 23, the hand rod 61 has to be turned to keep the axis of the jaw 62 driven by the eccentric wheel 611 to move inward, enabling the second cam 322 driven by the jaw 62 to move toward the first cam 321, so that the wheelbase of the driving cam member 32 is shortened. By the time, the driving belt 50 relatively moves toward the outer circumference of the driving cam member 32, increasing the radius for the driving belt 50 to turn around the driving cam member 32. And, as the length of the driving belt 50 is definite, the driving belt 50 is therefore to move toward the axis of the driven cam member 42 so that the wheelbase of the driven cam member 42 is to be lengthened, relatively shortening the radius for the driving belt 50 to turn around the driven cam member 42. Therefore, the pulley 311 of the driving shaft 31 is to drive the driven chain gear 411 to increase its RPM, enabling the switch chain gear 732 and the input roller 23 to increase their RPM too. Thus the input speed of a workpiece is speeded up thereby.

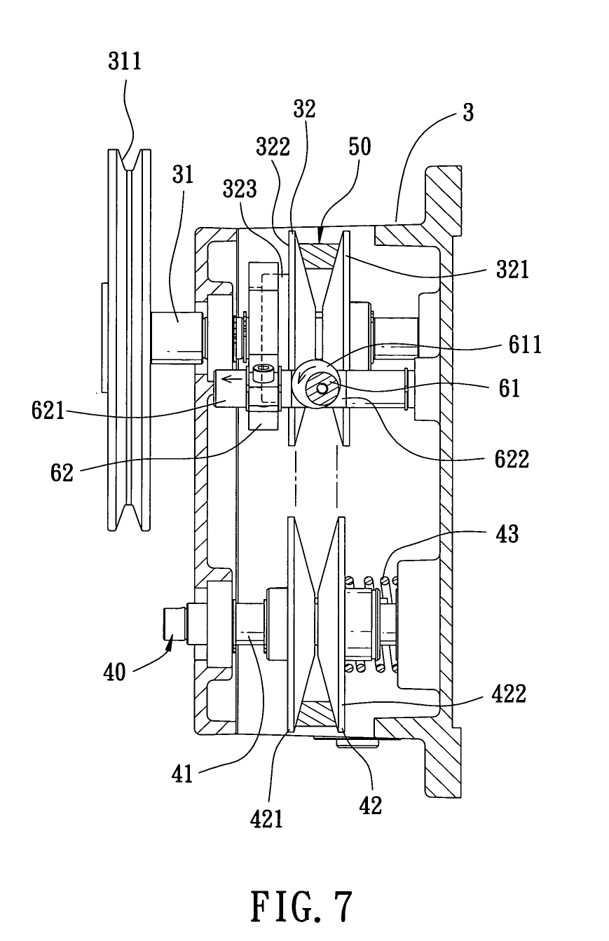

As shown in FIG. 7, when it is hoped to slow down the input roller 23, the hand rod 61 has to be turned again to keep the axis of the jaw 62 driven by the eccentric wheel 611 to move outward, enabling the second cam 322 driven by the jaw 62 to move farther away the first cam 321, so that the wheelbase of the driving cam member 32 is lengthened. Of course, then the driving belt 50 moves closer to the axis of the driving cam member 32, reducing the radius for the driving belt 50 to turn around the driving cam member 32. By the time, the fourth cam 422 of the driven cam member 42 is to be forced by the elasticity of the compression spring 43 to move toward the third cam 421, shortening the wheelbase of the driven cam member 42, increasing the radius for the driving belt 50 to turn around the driven cam member 42. Therefore, the belt pulley 311 is to drive the driven chain gear 411 to decrease its RPM, enabling the input roller 23 to decrease its RPM, too.

In addition, it should be noted that the contact surface between the eccentric wheel 611 and the driving groove 622 is aligned with the axis of the hand rod 61 while the eccentric wheel 61 is rotating in the driving groove 622, keeping the contact area from generating any torque, so that the hand rod 61 is to stay steadily without necessity of other fixing device after having turned with a preset angle, very convenient for operation.

The invention has the following advantages as can be seen from the foresaid description.

1. The stepless transmission 3 in the present invention is based on change of the rotating radius of the driving cam member 32 and the driven cam member 42, driven by the driving belt 50, to alter speeds for any planning speed as required, relatively upgrading working precision.

2. The eccentric wheel 611 is aligned with the contact surface of the driving groove 622 so as to keep the eccentric wheel 611 from generating any torque, enabling the hand rod 61 to stay steadily without necessity of other fixing device after having turned with a preset angle, very convenient for operation.

While the preferred embodiment of the invention has been described above, it will be recognized and understood that various modifications may be made therein and the appended claims are intended to cover all such modifications that may fall within the spirit and scope of the invention.

What is claimed is:

1. A stepless transmission for a flat planer, wherein said flat planer has a main base fixed with a motor inside it, an axis of said motor set with a belt pulley to drive a knife shaft pivotally fixed on said main base to rotate, two sides of said knife shaft pivotally connected with an input roller respectively that is also driven by said motor to convey a workpiece, said stepless transmission comprising:
a driving pulley set provided with a driving shaft at its front end connected with said motor, said driving shaft fitted with a driving cam member able to change its wheelbase and projecting gradually from two sides of its outer circumference to its axis;
a driven pulley set provided with a driven shaft pivotally connected in said stepless transmission and a driven cam member able to change its wheelbase and corresponding to said driving cam member, said driven cam member projecting gradually from two sides of its outer circumference to its axis;
a driving belt mounted between said driving cam member and said driven cam member;
a hand rod set provided with a hand rod and a jaw, said hand rod inserted in said stepless transmission with its handle remained outside and provided with an eccentric wheel at its end connected with said jaw, said jaw pivotally connected at one side of said driving cam member of said driving pulley set, said eccentric wheel able to drive said jaw to move eccentrically so as to alter the wheelbase of said driving cam member; and
a switch gear set provided with a main shaft connected with said driven shaft and a switch chain shaft linked with said input roller.

2. A stepless transmission for a flat planer as claimed in claim 1, wherein said driving shaft is fixed with a belt pulley connected with said motor by a belt.

3. A stepless transmission for a flat planer as claimed in claim 1, wherein said driving cam member is composed of a first cam fixed deadly on said driving shaft and projecting gradually from its outer circumference to its center, and a second cam projecting also gradually from its outer circumference to its center and pivotally fixed on said driving shaft to be driven by said jaw to reciprocate axially

4. A stepless transmission for a flat planer as claimed in claim 1, wherein said driven cam member is composed of a third cam fixed deadly on said driven shaft and a fourth cam pivotally fixed on said driven shaft that is fitted with a compression spring outside said fourth cam for forcing elastically on said fourth cam axially.

5. A stepless transmission for a flat planer as claimed in claim 1, wherein said driving belt is a V-belt.

6. A stepless transmission for a flat planer as claimed in claim 1, wherein said jaw is provided with a jaw shaft that, pivotally fixed in said stepless transmission and intersecting with said hand rod, is provided with a driving groove for fitting said eccentric wheel.
